(19) United States
(12) Patent Application Publication
(10) Pub. No.: US 2008/0109481 A1
(43) Pub. Date: May 8, 2008

(54) CONTEXT BASED NETWORK SEARCH

(76) Inventors: Sergio Catanzariti, San Francisco, CA (US); Lance Pham, San Jose, CA (US); Aditi Karandikar, San Francisco, CA (US)

Correspondence Address: THORNE & HALAJIAN;APPLIED TECHNOLOGY CENTER, 111 WEST MAIN STREET, BAY SHORE, NY, 11706, US

(21) Appl. No.: 11/556,773

(22) Filed: Nov. 6, 2006

(51) Int. Cl. G06F 17/30

(52) U.S. Cl. 707/104.1; 707/E17.008

(57) ABSTRACT

A network-based publish/subscribe model wherein a subscription request is received over the network from a subscriber and a community of interest is identified based on at least one of the subscription request and a network parameter related to the subscription request. The community of interest plus other related information, like a user service profile and a network information element, may be identified during the subscription request. Data pertaining to the subscription request and additional data pertaining to the community of interest is retrieved and transmitted to the subscriber. The additional data may be based upon the other related information. In one embodiment, the subscription request and the additional data are related to a same community of interest and other related information. The subscription request may be received by a content aware router.

### FIELD OF THE PRESENT SYSTEM

The present system relates to an architecture arranged to support network-based searching, such as prospective searching and data distribution service over an application and network infrastructure.

### BACKGROUND OF THE PRESENT SYSTEM

Systems for searching available data on the Internet are well know. Software for searching the available data, termed “search engines” use web-crawlers to comb available Internet sites for the data while an indexer program reads the data and associated metadata to create a searchable index based on “key terms” contained in the data and metadata.

Accordingly, a search performed on a search engine is actually a search of a corresponding index that returns data related to search terms. These search engines are very useful when the intent of a search is to return a broad array of data related to a given easily definable topic. However, when the intent is to identify a small sub-set of the available data due to a particular interest, it can at times be difficult to identify particular data that may be of interest without having to wade through a large number of only incidentally related data. For example, a search of a term, such as “Alaska” on a publicly available search engine will return millions of documents that contain the term including travel data (airfare, lodging, etc.), state-hosted data (land mass, weather, budget, elections, flag, map, etc.), university information, as well as other data that merely contains the term “Alaska” such as a listing of the states of the United States of America. However, in a case wherein a user is interested in a very small subset of the available data, this type of “open search” may be very frustrating. Certainly more terms may be added to a search string to try and narrow returned data, however, even then undesired data may be returned.

To alleviate this problem, specialized search engines have been introduced that only index data related to an identified subset of the available data. These search engines perform what is termed, a “vertical search” within the subset of available data. Since the indexed data is only related to a subset of the available data, these vertical search engines have an ability to return data that is not only relevant to a search term but is also restricted to a certain community of interest without requiring entry of a potentially complex series of search terms to define the community of interest. For example, a simple search of the term Alaska on a vertical search engine dedicated to hiking information, only returns data related to Alaska hiking as opposed to an exhaustive return on everything that mentions Alaska. This has an enormous advantage both for the searcher who is only interested in a subset of available data as well as for an advertiser (publisher) who is interested in reaching a particular target audience.

Legacy search systems, both broad and vertical ones, are classified as historical search systems due to the property that these systems search for historical information. In other words, legacy search systems look for content that already exists, on the web and/or within data bases, prior to the time of the search. Legacy search system are also polling-based systems because they have the property of polling through a certain number of historic content sites in order to discover new updates or content changes.

A new type of search system, called prospective searching, has instead the property to look for content, or any update, that still has to happen or be updated. In other words, prospective searching supports the subscription/publication paradigm. These prospective search systems are a type of push systems or real-time systems in the sense that they do not store content, but merely store queries, such as content interest descriptions (subscriptions). In operation, when content from a site (called publisher) or its update is generated matching those interests, the subscriber receives the content in a push, real-time fashion without any polling needs. XML routers are a type of recent system capable of supporting natively this publisher/subscriber prospective search model.

User groups (a publish/subscribe model) operate similarly in that a user subscribes to a user group of interest (e.g., HAM radio operators) with a particular hosting service. In a user group, information of interest is pushed, as opposed to pulled by a user's search query as in a vertical search, to the members of the user group as relevant data is published.

While these systems (e.g., vertical search engines and user groups) inherently utilize information about the community of interest to narrow the field of relevant data that may be retrieved, the semantic parsing of search terms and available data is little better than that utilized for general searching with the exception that the available data is narrowed to correspond to the community of interest.

Existing vertical search engines and publish/subscribe content delivery systems do not have the ability to correlate certain properties of network and user information to focus retrieved data beyond the above semantic limitations.

Another problem that exists in directing data to a community of interest is that numerous stream-based applications are distributed and contain data sources and consumers geographically scattered across the Internet. Data streams may be routed based on the content of the data stream, from a data source to a destination where the data stream will be consumed. What is known as “content-based routing” differs from traditional IP-based routing in that a routing decision is made based on the data being transmitted rather than any routing information attached to it. In this model, sources generate data streams according to application-specific schemas, with no particular destinations associated with them. Therefore, the destinations are autonomous from the producers of the messages and are instead identified by the ‘data consumers’ interests, which are commonly expressed through declarative specifications, called profiles or subscriptions. Profiles are usually specified as query predicates over application schemas. Content-based or semantic routing aims to efficiently identify and route the relevant data to each consumer.

However, existing extensible Markup Language (XML) routing-based publication/subscription platforms are still limited to the particulars specified within the profiles and do not allow or support additional inferences about subscriptions to expand on data that may be of interest.

U.S. Patent Publication No. 2006/0085750 to Easton et. al. incorporated herein by reference thereto, describes a method for web-based help for task or transaction oriented web-based systems. The method includes generating a reference taxonomy (information defining a first data organization), accessing storage associated with a message broker to obtain a taxonomy of message topics used by the broker for routing of messages, and comparing the reference and topic taxonomies to identify matching features within the taxonomies. The results of the comparison may then be used to retrieve help information associated with a matching taxonomy. The reference taxonomy may be created, edited, and two or more taxonomies may be integrated to provide a reference taxonomy. This system extends a typical search criteria utilizing taxonomies to provide a way to organize data within the publish/subscribe model yet still has no ability to create value added search services by integrating network information with application information or to extend a request beyond a requesting subscription.

### SUMMARY OF THE PRESENT SYSTEM

It is an object of the present system to overcome disadvantages and/or make improvements in the prior art.

The present system includes a method and device for supporting a network-based publish/subscribe model. In accordance with an embodiment of the present system, a subscription request is received over the network from a subscriber and a community of interest is identified based on the subscription request and/or a network parameter related to the subscription request. For example, the community of interest may be identified during the subscription request processing by means including configuration information, service parameters, user profile, service profile, and/or network attributes, etc. Data pertaining to the subscription request and additional data pertaining to the community of interest is retrieved and transmitted to the subscriber. This may be achieved by using new inferred and automatically generated subscriptions (e.g., Xpath) built on a different taxonomy (e.g., XML schema) mapped from a taxonomy where the original subscription was built on, by both the original subscription request and the mapped subscription sharing the same community of interest. In other words, in one embodiment the subscription request and the additional data may be members of a same community of interest.

In accordance with a further embodiment, the subscription request is built from a taxonomy representing a requesters interest. The requesters taxonomy may be compared to taxonomies representing a plurality of communities of interest. The community of interest may be retrieved from one of the plurality of communities of interest. A user profile related to a user that submitted the subscription request may be retrieved including network information. A taxonomy including information from the user profile and the network information may be retrieved to instantiate a new subscription related to the network-based taxonomy. The network information may include one of user location, presence and usage information.

In accordance with one embodiment, the subscription request may be received as an XML content interest expressed in an Xpath query. The network level elements may be bound to the subscription request. The additional data may be retrieved in response to the subscription request including the bound network level elements. The network level elements may include at least one of a service level agreement (SLA), a class of service (CoS), security, location, and presence.

In one embodiment, further additional information may be retrieved that is related to the network information and may be transmitted together with the data and the additional data. For example, the network information may be used to build a new subscription request (e.g., the additional information) by using a related taxonomy aimed to allow the user to receive the original subscription data plus additional data customized with some network-based attributes. The additional information may be provided by a publisher that submits a fee to become a member of a community of interest, for example of the same community of interest as the user's subscription request. The same monetization capability may be offered by the system related to the user subscriber as well paying a fee to receive value-added content enriching the original content request based upon some tiered premium service levels.

### BRIEF DESCRIPTION OF THE DRAWINGS

The present system is explained in further detail, and by way of example, with reference to the accompanying drawings wherein:

FIG. 1 shows an illustrative user network information tree that provides presence enhanced information for a community of interest-based taxonomy and service correlation engine in accordance with an embodiment of the present system; and

FIG. 2 shows an illustrative system in accordance with an embodiment of the present system.

### DETAILED DESCRIPTION OF THE PREFERRED EMBODIMENTS

The following are descriptions of illustrative embodiments that when taken in conjunction with the drawings will demonstrate the above noted features and advantages, as well as further ones. In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims. Moreover, for the purpose of clarity, detailed descriptions of well-known devices, circuits, and methods are omitted so as not to obscure the description of the present system. In addition, it should be expressly understood that the drawings are included for illustrative purposes and do not represent the scope of the present system.

In accordance with the present system, a method for organizing data within a publish/subscribe model for integrating network information with application information is described to provide value added search services on application oriented networks. In accordance with an embodiment of the present system, taxonomies may be applied to organize communities of interest information, such as pertaining to a user interest, and dynamically injecting/integrating related network information such as user profile, location, presence, billing and usage information, etc., to extend prior systems for identifying additional data that may be relevant within the context of a subscription and thereby extend prior systems, such as prior subscription service models. Thus, in accordance with the present system, the ability to create value added search services is provided by better integrating network information with application information rather than merely providing a way to organize data within publish/subscribe model as is previously known. Thus, additional, more valuable, granular or customized content may be generated by automatically creating new subscriptions based upon, for example, community of interest based taxonomy mapping, correlation and/or network information integration processes.

In accordance with one embodiment, the present system may take advantage of publish/subscribe based XML overlay network technologies to facilitate the binding of transport network level elements like service level agreement (SLA), Quality of Service (QoS), location, presence, etc., to vertical closed communities of interest based searches.

In accordance with the present system, a granular grouping of publishers and subscribers, for example into vertical user interest communities combined with network level elements like SLA, class of service (CoS), security, location, presence, device profiles, user profiles, etc., enables delivery of semantic, targeted, context based information to subscribers that heretofore was unavailable with different levels of service differentiation.

The present system's network leverage may be partly based on extending nodes of a taxonomy of a community of interest to include items such as network service SLA and “presence”. As utilized herein, the taxonomy may be a categorization of information related to certain business segments, verticals, or to a universe of discourse. The taxonomy may be expressed merely as an unstructured collection of information or may be expressed as a hierarchical structure of information, wherein the hierarchy provides additional relational information (e.g., parent/child) associate with the information. The taxonomy may relate to the subscription request or may relate to network level elements. For example, the taxonomy may relate to the (original) subscription request semantic, in a structured way by using XML-based taxonomy instantation structures like XML schema or DTDS, or may relate to formal network level element representations by using formal SLA, SLS and network and system management structure elements.

For example, in case of context based presence leveraged applications in accordance with the present system, users may advertise their reachability, binding this information for example with their location, preferred communication tool and media capabilities. This information may be collected and maintained by an event notification engine, a function for example of a semantic router, to facilitate the delivery of data that is extended beyond what would have been previously provided without this additionally bound information.

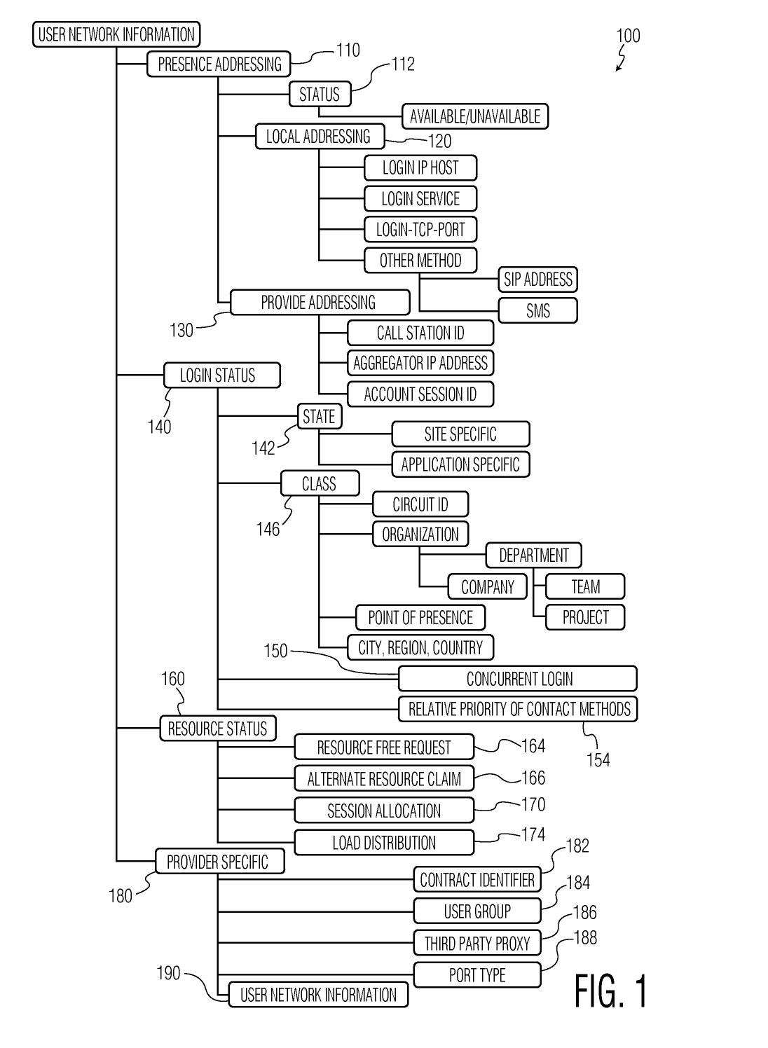

FIG. 1 shows an illustrative user network information tree 100 that provides presence enhanced information for a community of interest-based taxonomy and service correlation engine that maps messaging and presence information to deliver richer, more personal content services in accordance with an embodiment of the present system. The network information tree 100 may be provided having a hierarchical structure of elements wherein the hierarchy provides relational information of associated nodes. As such, the user network information tree 100 may include presence addressing 110, login status 140, resource status 160, and provider specific information 180. The presence addressing 110 may include status 112, local addressing 120, and provider addressing 130, with each illustratively providing more detailed information as further nodes of the tree as shown. The login status 140 may include a login state 142, a login class 146, concurrent login 150, and relative priority of contact methods 154, with one or more of each illustratively providing more detailed information as nodes of the tree as shown. The resource status 160 may include resource free request 164, alternate resource claim 166, session allocation 170, and load distribution 174. The provider specific information 180 may include contract identifier 182, user group 184, third party proxy 186, port type 188, and user network information 190.

With the growth of XML traffic, new technologies have emerged that allow routing and delivery of information based on content rather than IP address, such as content based routing. Service providers today would like to leverage the intelligence and the content aware aspects of their networks to allow them to create more targeted, for example, context based services. Prior application based search systems do not have an ability to infer network level information about a user such as QoS, location, presence, current active device, etc., that are controlled by the network service provider. In accordance with an embodiment, the present system leverages additional discernable information, such as content based routing paradigms, taxonomy correlation and network service information, to create a semantic network based search platform able to provide rich content services for enterprises and consumers.

In accordance with an embodiment, the present system provides extensions to existing publish/subscribe service models such that subscriptions may be correlated and created based on taxonomy and network service profiles classification and correlation functions that interact with aware network systems, such as prospective network-based search systems including XML routing based platforms, through, for example, a service management interface. These extensions may also enable delivery with a subscription service level profile such that an XML Routing platform may request a certain network service level to the underlying transport network through an Inter Working Function (IWF) to, for example, fulfill end-to-end application SLAs.

In accordance with an embodiment of the present system, a functional reference of a service delivery and implementation model over a set of existing key technologies may require a new definition of functional interfaces previously absent or undefined. While XML Routing publish/subscribe commercial platforms previously existed, these platforms did not support or fully implement the service reference model currently proposed, nor its functionality and interfaces. In fact, previous subscription tables in the XML Routers are not filled looking at a taxonomy inference engine or network service profiles. Prior systems, typically only examined a propagation of a path expression, such as XPath for example, in the case of XML-based subscriptions.

A service implementation and delivery functional reference model may be provided for a network-based context search using, for example, an XML routing platform including publish/subscribe XML routing, a network service profile and taxonomy correlation, such as user and network taxonomy correlation.

In accordance with an embodiment of the present system, a network service profile may be added as a part of an XML based subscription model. FIG. 1 shows one embodiment of a tree-based model of network-based information that may be used to build a taxonomy. In this way, by extending the subscription service model with elements coming from the transport network, the present system may enhance the context of the subscription (e.g., community of interest) and enhance the ability to populate the subscription tables without any specific actions required by the user application. An architectural reference model may be defined including new functional blocks (e.g., taxonomy mapping functionality) and a functional interface inside the XML routing functional block, between a subscription processing module and a taxonomy mapping function. In addition, an interface may be defined between a “community of interest” and network service parameters. For example, transport service parameters may communicate over an ad hoc inter-working function (IWF) positioned between XML routing-based machinery and IP routing-based machinery, over which the XML routers may be enabled to communicate service parameters over service primitives understood by the underlying transport network, so that the service parameters may be part of the interface definition.

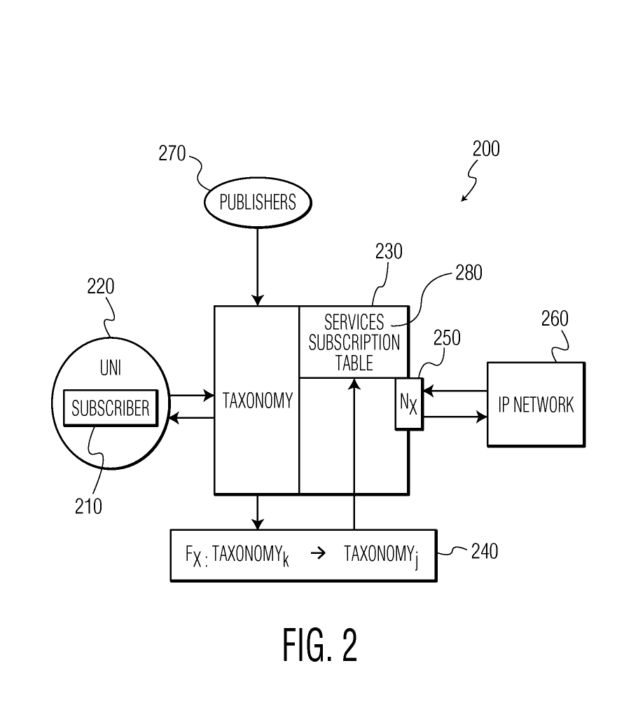

FIG. 2 shows an illustrative system 200 in accordance with an embodiment of the present system. As illustratively shown, a subscriber 210 may send a subscription request via a user network interface (UNI) 220 to an XML router 230. For example, a CDN (content delivery network)—IP (Internet Network) UNI may be an instantiation of this UNI, considering that an XML routing-based network is a model of an overlay CDN network, and the IP network is the underlying network over which CDN is built on. A CDN-IN UNI is an example of a service interface between a subscriber application service interface and an XML router subscription service interface in accordance with an embodiment of the present system. An example of a UNI message for a subscription service request may be in the form of:

Subscription Service Request Y={user A, XPATH, ComnunityOfInterest x}.

### In response to the subscription request, the XML router 230 calls a function Fₓ (240):

Taxonomyₖ→Taxonomyⱼ,

wherein Fₓ, operating as a function instance selector, may be a parametric function, in other words, it may be a set of “function instances” or a “function family”, that maps or correlates a Taxonomy K (domain of a function) to another Taxonomy J (co-domain of a function), for example, based upon the Taxonomy K and the Taxonomy J belonging to a certain “Community of Interest” X. An example in accordance with this embodiment may represent a Community of Interest X that is “Movie Industry”, and a specific function “F” related to a domain of “Movie Industry”. For example, an embodiment of the present system may map “movie theater information space” (mapping Taxonomy K) to “ticketing agency information space” (Mapped taxonomy J) based on each being part of the Community of Interest, Movie Industry. In this way, the user may be provided with additional information beyond the user's particular subscription request that is relevant to a community of interest, of which the user's particular subscription request is a member. The subscription request may be in a form of Xpath which acts as a filter of one or more XML publications. Through the Xpath, relevant portions of the XML publications may be retrieved. The subscription request, for example in the form of Xpath, may be identified as a member of a given community of interest. In accordance with an embodiment of the present system, the subscription request may be mapped to another member of the community of interest to provide an additional subscription beyond the original subscription request.

As may be readily appreciated by a person of ordinary skill in the art, there are numerous other functions that may be utilized to map a particular subscription of interest to another related subscription without the subscriptions necessarily belonging to a same community of interest. For example, a taxonomy of the subscription request may be compared to taxonomies of other available subscriptions to identify similarities within the taxonomies that indicates that additional subscriptions may be of interest. Further, a look-up table of taxonomies may be provided wherein best-fit additional taxonomies are compared to the subscription request. Additionally, publishers may enter suggested related taxonomy data for typical subscription requests. Publishers may be charged for this ability to reach a broader subscriber audience than previously attainable. Other systems for providing the function F (item 240) would be readily appreciated by a person of ordinary skill in the art and are intended to be covered within the claims that follow.

In any event, in one embodiment in accordance with the present system, the XML router 230 calls a Network service profile Nₓ (250):

CommunityOfInterest x→{NetworkServiceParameters} x thereby mapping the CommunityOfInterest x to the {NetworkServiceParameters} x.

The XML router 230 communicates the {NetworkServiceParameters} x to a Transport Network (IP Network 260) over an Inter Working Function (IWF) for the publication delivery service semantics related to Subscription Service Request Y. CDN-TN IWF may be defined as a service gateway interface between the XML routing-based network and the IP network. The publication delivery service semantics may be in a form as shown in FIG. 1 for example including elements of presence enhanced information for the community of interest-based taxonomy, thereby enabling a service correlation engine to map messaging and presence information to deliver richer, more personal content services. The present system may also enable usage of certain forms of SLA to deliver publisher content to the user/subscriber meeting certain levels of service attributes that may be monetized (e.g., delay, response time, guarantee, security, etc.).

The IP Network 260 returns network service parameters values to the XML router 230 to be used in generating a network service based subscription or for inducing publication content processing into the system. For example, publishers may provide relevant subscription data containing content that requires a high-bandwidth subscriber connection (e.g., audio/visual content) having graphics processor capabilities, as well as similar text based data suitable for thin-clients over a low-bandwidth connection and other data meeting other network parameters.

The network service profile request may be a function or a set of functions (e.g., one per community of interest), that sends service attributes requests from an XML routing service point (Nₓ 250) to the underlying IP transport network 260 over an apposite interface IWF operating between the XML router 230 service network and the transport of the IP network 260. In accordance with an embodiment of the present system, the network service profile request may serve as a request of service attributes for publication content delivery and further may result in a retrieval of network attributes and properties to be used in automatically generating intelligent, or network aware, further subscriptions beyond the requested subscription.

In one embodiment, the service attributes request over the IWF from the XML router 230 to the IP network 260 may be expressed as a t-upla made of several network service elements specific to a business segment, or community of interest, that some publishers and subscribers belong to. For example the network service attributes for the Entertainment Industry may be: [security level (high), QoS class (standard), reliability level (gold), delivery mechanisms (SMS number & phone number), etc.] that may be utilized to fulfill the requested and inferred subscription.

In accordance with a further embodiment, for example over the same IWF, the present system may run another instance of the network service profile request (or operate on the first instance of the network service profile request) that, depending on a given business segment or community of interest, may make a request to the underlying IP network 260 of a set of network attribute values to be returned to the XML router (e.g., an XML routing service engine), to generate an automatic subscription, based not upon taxonomy mapping, but on returned or provided network attribute values. In this way, the present system may utilize some network and transport layer information relating to the subscriber to generate new subscriptions from the original subscription request. For example, the source address of subscriber “A” may be utilized to infer a point of presence (PoP) location, region, state, etc., to generate locally derived community publisher content such as airport shuttle service, car rental, storage garage, security surveillance, pet accommodations, etc.

For example, a mode of communication of the subscriber, such as WiFi, DSL, mobile-3G, mobile EVDO, etc., may be utilized in accordance with the present system to generate a content publisher request to a certain class of publishers using certain content transformation features and/or issuing a publication content processing request to the pub/sub service system allowing publishing across all modes. Other network features may be utilized for identifying suitable data and delivery options including alert options, fall back, preferred (e.g., as depends on the subscriber service package). A time stamp and geo location for source and destination may, for example, be used to trigger publication of dining and entertainment venues; specials, weather gear, etc. Circuit statistics, such as how often the PoP receives certain subscriptions properties, like travel patterns, time, etc. may be utilized to infer a scale for promotions and cross promotions for content providers, advertisers, etc. all in the publisher chain related to a community of interest.

In accordance with a further embodiment of the present system, subscriber service packages such as triple play bundles, features, SLA, multicast announcements support, IPTV, VoIP message, notice on PVR service, suggestion of destination bookings, etc., may be inferred from an original subscription alert request for lodging specials. The inferred subscription may be provided related to an available inferred network structure, such as a Broadcasters' show schedules that are available to the subscriber as inferred from the subscriber accessed network, such as cable TV.

Further, a subscriber domain (e.g., family and social networking, technically realized on the network, such as group preferences, community of interest, user profiles, etc.) may be even utilized in accordance with an embodiment of the present system to call a taxonomy mapping function, Fₓ, for a correlated vertical industry x, or community of interest, for subscription mapping.

In any event, suitable subscription data, for example provided by publishers 270, may be retrieved based on parameters of the particular Subscription Service Request Y.

In accordance with an embodiment of the present system, the XML Router 230 may update a services subscription table 280 with 2 or more additional entries:

| | |
|---|---|
| user A | Subscriptionₖ |
| user A | Subscriptionⱼ |
| user A | Networkservice based Subscription K |

wherein Subscriptionₖ corresponds to subscription data from the original subscription request (e.g., movie theatre information space expressed in Xpath); Subscriptionⱼ corresponds to subscription data from the community of interest returned by function F (240); and Networkservice based Subscription K is returned by the IP Network 260 or determined from data returned from the IP Network 260.

Thereafter, in accordance with an embodiment of the present system, the XML router 230 sends to user A (subscriber 210) data (e.g., documents and/or portions of documents) that match Subscriptionₖ AND Subscriptionⱼ AND Networkservice based Subscription K, delivering the data according to {NetworkServiceParameters}x semantics.

Following are some illustrative scenarios of an application of a system in accordance with embodiments of the present system.

In a semantic content-based advertisement network assuming a network service provider A supports a closed community of interest-based publisher/subscriber content services through an XML routing platform. Publisher groups including Airlines, Hotels, etc., is provided and network level information about subscribers is available. In this scenario, users may subscribe to a publication from a certain community of interest. The context based network search service, in accordance with an embodiment of the present system, may interleave advertising content coming from the community of interest partners with the subscribed publication and may apply a network service profile to deliver all the matched content to the subscriber.

In a further embodiment, context based business-to-consumer (B2C) content services (Publish/Subscribe Transact) may be provided, thereby supporting business partnership models. Assuming that a network service provider A supports a closed community of interest-based publisher/subscriber content services through an XML routing platform. Publisher groups including Airlines, Hotels, etc. is provided and network level information about subscribers is available. In this scenario, users may subscribe to information about a business service from a certain community of interest. Businesses publish business information to the XML routing platform. The context based network search service may correlate, based on the business semantics of the original subscription, to allow publication from a different business partner in the same community of interest to be automatically delivered to the subscriber applying the network service profile of the subscriber. This is aimed to facilitate Pub/Sub→Transact business models. As an example, an Airfare flight inquiry may result in an Airfare+Hotel reservation transaction.

Another scenario in accordance with an embodiment of the present system may be aimed to support a business-to-business (B2B) content service related to a Class of Service (CoS) based content delivery system. A network service provider A may support a closed community of interest-based publisher/subscriber content services through an XML routing platform. Publisher groups may include financial market data and network level service information about publishers and subscribers is available. An enterprise may subscribe to a certain business community of interest. The context based network search service may correlate the delivery of time sensitive information coming from another partner in the same community of interest applying network Service Level Agreement (SLA) policies (e.g., determined from data returned by the IP Network 260) related to the community of interest or the specific publisher, to the delivery of information.

Accordingly, one aspect in accordance with the present system relates to an inferred subscription through taxonomy mapping. In this embodiment, a new subscription J is inferred from a subscription K coming from a user A. Subscription K may express an interest for a new publication, not explicitly requested by user A, but, for example, semantically related to subscription K. The inference may be based upon the belonging of the subscription K, illustratively expressed as a t-upla (e.g., subscriber X, publisher Y, subscription K, publication T) related to a certain community of interest x. In this embodiment, the new inferred subscription J may be a result of an automatic subscription generation function that takes as input a subscription J which is mapped to a subscription K based, for example, upon a community of interest x (or another relationship as would be readily apparent to a person of ordinary skill in the art). This function may be in reality a set of functions, such as one or more functions per community of interest.

For example, the subscription K may be provided by the user A to an XML router through an Xpath structured request. Xpath is a language that enables expression of a subscription interest from a user related to some publication, content, and/or portions thereof. As would be readily apparent, other forms of making a subscription request may be readily supported in accordance with the present system. Now, each Xpath is formed or constructed to conform to a certain XML format or schema. In accordance with an embodiment of the present system, the XML schema is a formal implementation of a taxonomy.

In an embodiment wherein the function Fₓ is a set of functions, one per community of interest, an existing and received subscription request from user A expressed in Xpath related to a subscription K, may be mapped “on the fly” to a new implicitly derived Xpath related to subscription J to be uploaded to the XML router.

In this way and in accordance with an embodiment of the present system, the present system infers a mapping of a taxonomy K to a taxonomy J. In this way, Xpath related to a certain taxonomy or XML schema (taxonomy J) in which a certain publication (or content) interest is structured, is mapped into another Xpath related to another taxonomy K in which another publication, or content, interest is expressed.

In this embodiment, the subscription request may result in a generation of the new inferred subscription since the function Fₓ provides a mapping of taxonomy K into taxonomy J, related to a community of interest x, and so an Xpath description for a subscription J is inferred from an Xpath request for a subscription K. An index of taxonomies may already exist prior to the subscription request so that the mapping is already defined.

The subscription request generally is a request to generate the new subscription K for the user A belonging to the community of interest x. In accordance with the present system, data relating to the new subscription J will also be provided or may be simply suggested to the user A in response to the request.

For example, a request for a Subscription K to look for a certain movie with a title “XYZ” may be expressed in an Xpath based upon an XML schema K, or taxonomy, called Movie Theater, belonging to a community of interest x, called Entertainment Industry. In accordance with an embodiment of the present system, an automatic subscription generation function may return a new Xpath, built upon an XML schema J, or taxonomy, called Ticketing Movie Agency, belonging to the same community of interest x, Entertainment Industry, expressing the new inferred subscription J. For example, the new inferred subscription may be to look for a certain ticket agency that sells tickets for the movie XYZ. This new automatic Xpath generation functionality may utilize the mapping function Fₓ to map taxonomy K to taxonomy J, thereby mapping Xpath for subscription K into Xpath for subscription J. In addition, taking network information such as presence, etc. in accordance with an embodiment of the present system, the taxonomy J may be used to return a ticket agency (subscription data) that sells tickets for the movie XYZ that is local to the user A requesting the subscription K or a further subscription L may be inferred. In the provided example, the community of interest may be a grouping of a set of taxonomies sharing certain business or “horizontal” properties, such as a community of interest x for entertainment industry, etc.

Additionally, or in place of the above embodiment, network information (e.g., QOS, billing, presence, location information, and other information of the like) may be utilized to infer the new subscription J and/or a further subscription L from the subscription K requested by the user A. The subscriptions related to the user A request in accordance with an embodiment of the present system (e.g., the user defined subscription plus the inferred subscriptions) may be utilized to provide data to the user.

The XML router 230 may include a processor operationally coupled to a memory that may, for example, include the services subscription table 280. The memory may be any type of device for storing application data as well as other data, such as the services subscription table, etc. The application data and other data are received by the processor for configuring the processor to perform operation acts in accordance with the present system. The operation acts may include receiving a subscription request, inferring a new subscription, retrieving subscriber network attributes and a service profile, offering publication content processing functionality and other operations (acts) of the like that may be typical of XML routing systems, such as described herein. Clearly the processor and memory may be part of the XML router 230 or may be a portion of a routing subscription service, such as an intelligent subscription service, semantic router, etc., of which the XML router 230 is only a portion.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory or other memory coupled to the processor.

The computer-readable medium and/or memory may be any recordable medium (e.g., RAM, ROM, removable memory, CD-ROM, hard drives, DVD, floppy disks or memory cards) or may be a transmission medium (e.g., a network comprising fiber-optics, the world-wide web, cables, or a wireless channel using time-division multiple access, code-division multiple access, or other radio-frequency channel). Any medium known or developed that can store and/or transmit information suitable for use with the processor may be used as the computer-readable medium and/or memory.

Additional memories may also be used. The memory, may be long-term, short-term, or a combination of long-term and short-term memories. These memories may configure the processor to implement the methods, operational acts, and functions disclosed herein. The memories may be distributed or local and the processor, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in the addressable space accessible by the processor. With this definition, information on a network is still within the memory, for instance, because the processor may retrieve the information from the network for operation in accordance with the present system.

The processor is operable to execute instructions stored in the memory. The processor may be an application-specific or general-use integrated circuit(s). Further, the processor may be a dedicated processor for performing in accordance with the present system or may be a general-purpose processor wherein only one of many functions operates for performing in accordance with the present system. The processor may operate utilizing a program portion, multiple program segments, or may be a hardware device utilizing a dedicated or multi-purpose integrated circuit.

Of course, it is to be appreciated that any one of the above embodiments or processes may be combined with one or with one or more other embodiments or processes to provide even further improvements in accordance with the present system. Additionally, any one of the above embodiments or processes may be separated into further processes or embodiments in accordance with the present system.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A method for supporting a network-based publish/subscribe model, the method comprising the acts of:
receiving a subscription request over the network;
identifying a community of interest of which the subscription request is a member;
retrieving data pertaining to the subscription request and additional data pertaining to another member of the community of interest; and
transmitting the data and the additional data in response to the subscription request.

2. The method of claim 1, comprising acts of:
structuring the subscription request into a taxonomy representing a requesters interest;
comparing the requesters taxonomy to a plurality of taxonomies, each one of the plurality of taxonomies representing one of a plurality of communities of interest; and
retrieving the community of interest from one of the plurality of communities of interest based on the comparing.

3. The method of claim 1, comprising acts of:
retrieving a user profile related to a user that submitted the subscription request;
retrieving related network information; and
creating a request based upon a taxonomy including information from the user profile and the network information; wherein the retrieving act comprises an act of retrieving the additional data in response to the created request.

4. The method of claim 3, wherein the network information includes at least one of user location, presence and usage information.

5. The method of claim 1, wherein the subscription request is received as an XML-based filter request document, the method comprising an act of:
binding network level elements to the subscription request, wherein the retrieving act comprises an act of retrieving the additional data in response to the subscription request including the bound network level elements.

6. The method of claim 5, wherein the network level elements include at least one of a service level agreement (SLA), a class of service (CoS), security, location, and presence.

7. The method of claim 1, wherein the additional information is first additional information, the method comprising acts of:
retrieving network information related to the subscription request;
retrieving second additional information related to the network information; and
transmitting the second additional information together with the data and the first additional data.

8. The method of claim 1, wherein the additional information is provided by a publisher that submits a fee to become a member of the community of interest.

9. A method for responding to a network-based subscription request, the method comprising acts of:
ordering a received subscription request into a taxonomy representing a subscribers interest;
comparing the subscribers taxonomy to taxonomies representing a plurality of communities of interest;
retrieving data pertaining to the subscription request and additional data pertaining to another subscription identified based on the comparing act; and
transmitting the data and additional data in response to the subscription request.

10. The method of claim 9, comprising acts of:
retrieving a network service parameter related to the additional data; and
communicating the network service parameter to a transport network, wherein the act of transmitting comprises the act of transmitting the data and additional data in accordance with the retrieved network service parameters.

11. The method of claim 10, wherein the network service parameter comprises at least one of network security, quality of service (QoS), reliability, and delivery mechanism.

12. The method of claim 10, wherein the network service parameter comprises a geo location for a subscriber and a publisher.

13. The method of claim 9, wherein the subscriber's taxonomy includes network service attributes that result in the retrieval of the additional data.

14. The method of claim 13, wherein the network service attributes includes a service level agreement (SLA).

15. The method of claim 9, wherein the subscription request includes network information including at least one of user location, presence and usage information.

16. The method of claim 9, wherein the act of comparing comprises acts of comparing the subscriber's taxonomy to taxonomies representing a plurality of communities of interest, and wherein the act of retrieving comprises the act of retrieving the additional data from the community of interest that pertains to the subscribers taxonomy.

17. A content aware router comprising:
a receiver configured to receive a subscription request;
a processor configured to identify a community of interest based on at least one of the subscription request and a network parameter related to the subscription request and configured to retrieve data pertaining to the subscription request and additional data pertaining to the community of interest; and
a transmitter configured to provide the data and the additional data.

18. The router of claim 17, wherein the processor is arranged to:
structure the subscription request into a taxonomy representing a requester's interest;
compare the requester's taxonomy to a plurality of taxonomies, each one of the plurality of taxonomies representing one of a plurality of communities of interest; and
identify the community of interest from one of the plurality of communities of interest.

19. The router of claim 17, wherein the processor is arranged to:
structure the subscription request based upon a taxonomy including the network parameter; and
identify the community of interest from the taxonomy.

20. The router of claim 17, wherein the processor is arranged to:
retrieve a user profile including network information related to a user that submitted the subscription request,
wherein the processor is configured to identify a related community of interest based on the user profile.
